(19) United States
(12) Patent Application Publication
(10) Pub. No.: US 2013/0118054 A1
(43) Pub. Date: May 16, 2013

(54) Invisitrap

(71) Applicant: Carol Gene Robinson, Baltimore, MD (US)

(72) Inventor: Carol Gene Robinson, Baltimore, MD (US)

(21) Appl. No.: 13/199,384

(22) Filed: Nov. 16, 2011

(51) Int. Cl. A01M 23/00

(52) U.S. Cl. 43/58; 43/124

(57) ABSTRACT

The Invisitrap is a rodent trap that comprises a clear vinyl plastic tray that can be attached to the surface via four adhesive strips located on the bottom of the plastic tray. The top of the tray is covered with glue that produces a smell similar to that of a peanut butter. The smell of the peanut butter attracts a rodent to the trap, where a rodent gets attached to the glue. The clear design of the plastic tray makes the Invisitrap almost indistinguishable to a rodent's eye.

### TECHNICAL FIELD

The present invention, in some embodiments thereof, relates to method for entrapping rodents, specifically with regard to rodent traps.

### BACKGROUND OF THE INVENTION

The present invention describes a glue rodent trap that features a novel design and is more effective than other rodent traps currently on the market.

### BRIEF SUMMARY OF EMBODIMENTS OF THE INVENTION

The present invention relates to a glue mouse trap that comprises a sturdy clear plastic vinyl tray that can be attached to a surface via four adhesive strips situated on all four sides of the bottom of the tray. The top of the tray is covered with glue that exhibits peanut butter scent that attracts rodents. The trap is almost indistinguishable to the rodent's eyes and is therefore an effective and hassle-free method for entrapping rodents.

In a variant, the plastic vinyl tray is clear.

In another variant, the length of the clear plastic vinyl tray is approximately 9 inches.

In yet another variant, the width of the clear plastic vinyl tray is approximately 5 inches.

In a further variant, the clear plastic vinyl tray has four adhesive strips situated on the bottom of the plastic tray.

In yet a further variant, adhesive strips situated on the bottom of the clear plastic vinyl tray are approximately 3 inches in length each.

Optionally, top of the plastic vinyl tray has an area covered with glue that extends out to ½ inches to all four sides of the plastic vinyl tray.

In a variant, glue area covering the top of the plastic vinyl tray is 1/16 inches deep.

In another variant, the glue covering the top of the plastic vinyl tray produces a smell similar to that of a peanut butter.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a diagram of the top of the Invisitrap;

FIG. 2 is a diagram of the bottom of the Invisitrap;

FIG. 3 is a picture of the package used for the Invisitrap

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

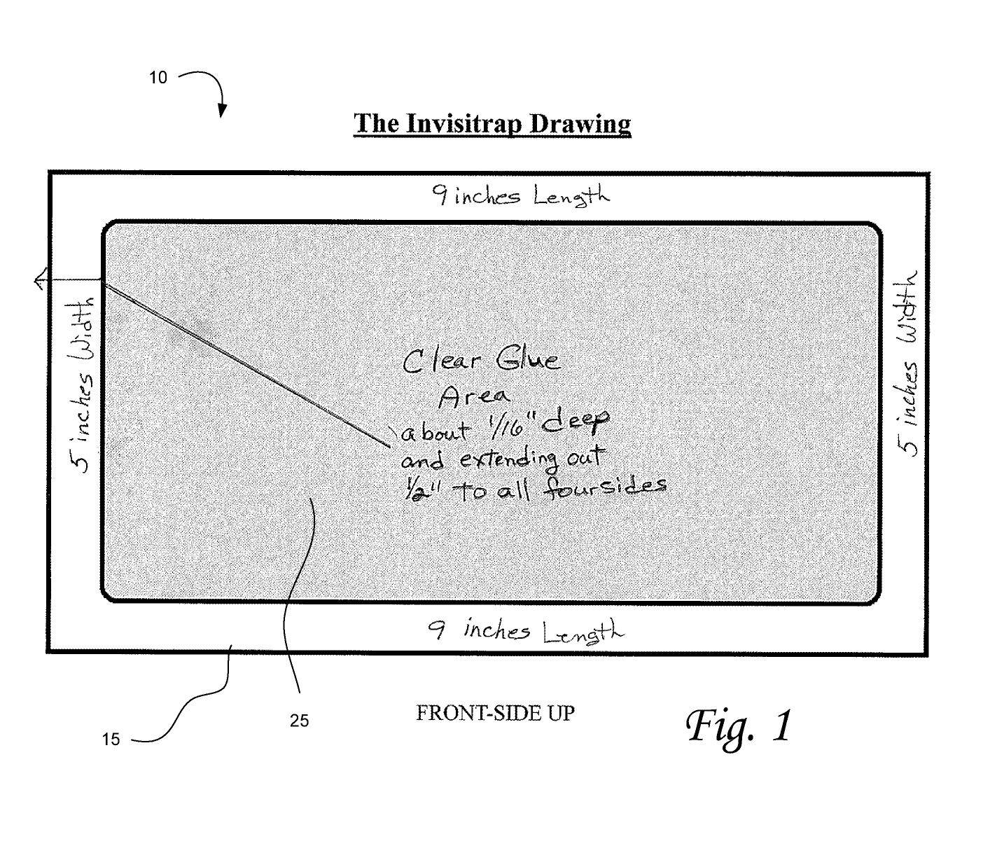

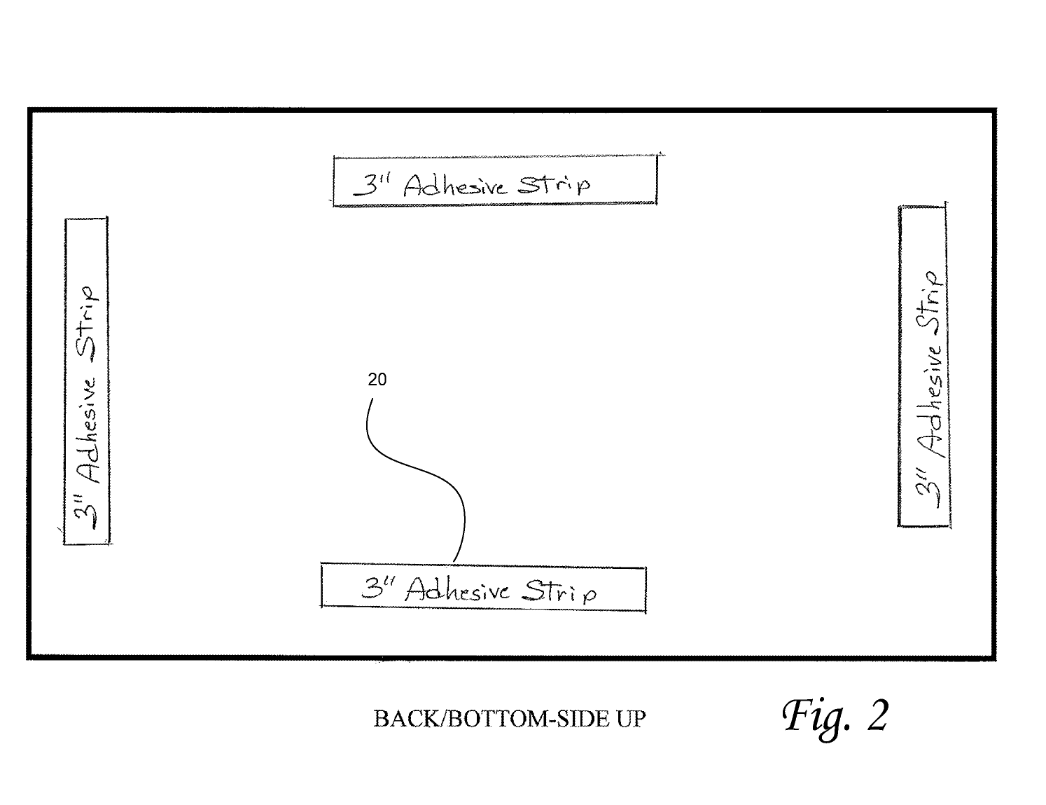

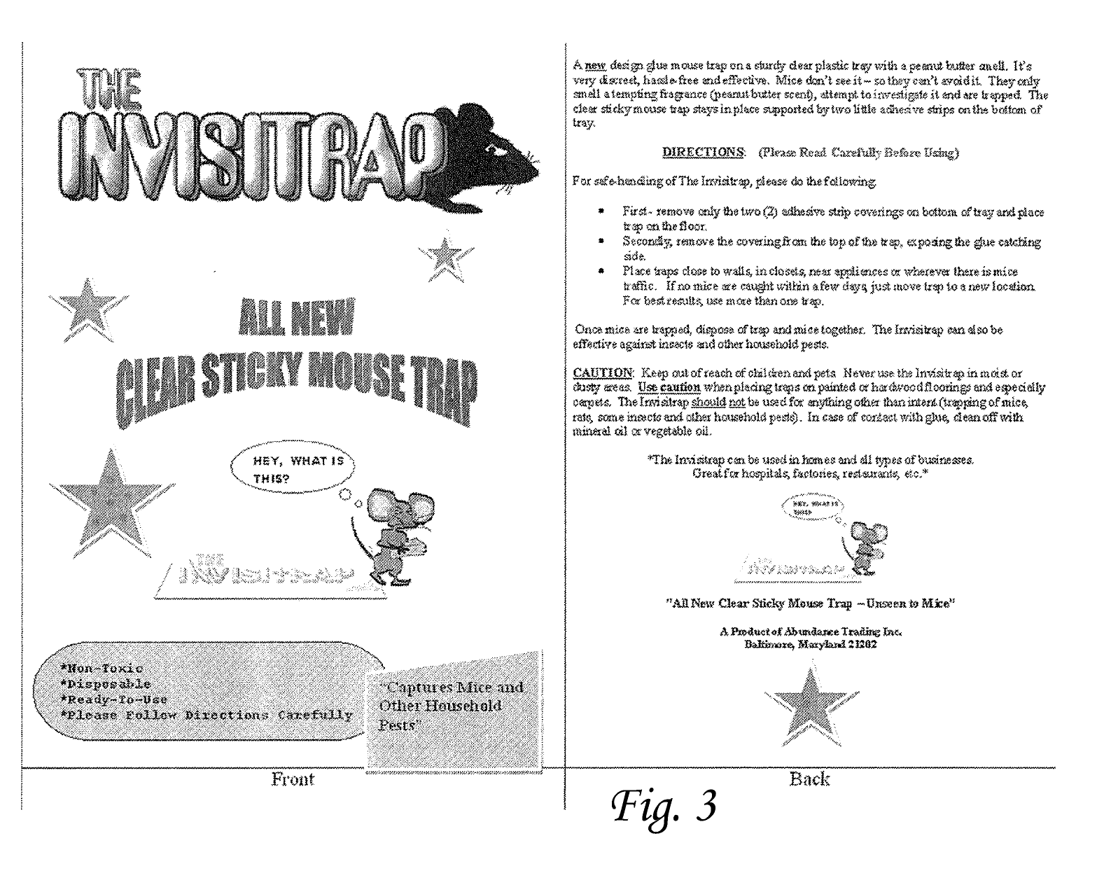

The present invention, in some embodiments thereof, relates to a novel mouse trap 10 that comprises a sturdy plastic vinyl tray 15 made of clear material. Referring to FIGS. 1-3, the tray 15 can be attached to a surface via four adhesive strips 20 situated on all four sides of the bottom of the tray. The top of the tray has an area 25, smaller than the area of the tray, covered with glue. The glue covering the top of the plastic vinyl tray exhibits a smell that resembles that of the peanut butter. The smell of the peanut butter attracts a rodent that goes to the area to investigate and becomes attached to the glue. Since the plastic tray is clear, the trap blends into the background and is not noticed by a rodent. The mouse trap is very discreet, hassle-free, safe and effective.

In a variant, the plastic vinyl tray is clear.

In another variant, the length of the clear plastic vinyl tray is approximately 9 inches.

In yet another variant, the width of the clear plastic vinyl tray is approximately 5 inches.

In a further variant, the clear plastic vinyl tray has four adhesive strips situated on the bottom of the plastic tray.

In yet a further variant, adhesive strips situated on the bottom of the clear plastic vinyl tray are approximately 3 inches in length each.

Optionally, top of the plastic vinyl tray has an area covered with glue that extends out to ½ inches to all four sides of the plastic vinyl tray

In a variant, glue area covering the top of the plastic vinyl tray is 1/16 inches deep.

In another variant, the glue covering the top of the plastic vinyl tray produces a smell similar to that of a peanut butter.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An apparatus for entrapping rodents comprising a plastic tray made out of a clear material.

2. An apparatus of claim 1, wherein the length of the plastic tray is approximately 9 inches.

3. An apparatus of claim 2, wherein the width of the plastic tray is approximately 5 inches.

4. The apparatus of claim 3 further comprising four adhesive strips situated on the bottom of the plastic tray.

5. The apparatus of claim 4, wherein the adhesive strips are approximately 3″ in length each.

6. The apparatus of claim 5, wherein the plastic tray has an area covered with glue.

7. The apparatus of claim 6, wherein the area covered with glue extends out to ½ inches to all four sides of the plastic tray.

8. The apparatus of claim 6 wherein the glue area covering the plastic tray is 1/16″ deep.

9. The apparatus of claim 8, wherein the glue area covering the plastic tray produces smell similar to that of a peanut butter.

10. A method of entrapping rodents, comprising the steps of
a. adhering an apparatus to a surface, the apparatus comprising:
a plastic tray made out of a clear material:
i. wherein the length of the plastic tray is approximately 9 inches;
ii. wherein the width of the plastic tray is approximately 5 inches; four adhesive strips situated on the bottom of the plastic tray:
iii. wherein the adhesive strips are approximately 3 inches in length;
wherein the plastic tray has an area covered with glue;
wherein the area covered with glue extends out to ½ inches to all four sides of the plastic tray;
wherein the glue area covering the plastic tray is 1/16 inches deep;
wherein the glue area covering the plastic tray produces smell similar to that of a peanut butter;
b. allowing the rodent to become attached to the glue area of the plastic tray.
c. disposing of the rodent.
